(19) United States
(12) Patent Application Publication
(10) Pub. No.: US 2012/0113681 A1
(43) Pub. Date: May 10, 2012

(54) LIGHTBAR MODULE AND BACKLIGHT DEVICE

(75) Inventors: Weiwei Zheng, Guangdong (CN); Poying Lin, Guangdong (CN)

(73) Assignee: SHENZHEN CHINA STAR OPTOELECTRONICS TECHNOLOGY CO., LTD., Shenzhen (CN)

(21) Appl. No.: 12/997,904

(22) PCT Filed: Nov. 26, 2010
(86) PCT No.: PCT/CN10/79152

§ 371 Date: Dec. 14, 2010

(30) Foreign Application Priority Data
Nov. 5, 2010 (CN) 201010536826.1

(51) Int. Cl. F21V 7/04; F21V 9/00

(52) U.S. Cl. 362/612; 362/235; 362/97.1

(57) ABSTRACT

The present invention discloses a lightbar module for use in a backlight device. The lightbar module includes a plurality of light source units. The light source unit includes at least one first light-emitting diode (LED) with a first color bin in a first wavelength range and at least one second LED with a second color bin in a second wavelength range. A color bin created by the mixed light of the light emitted by the first LED and the light emitted by the second LED after the mixed light passes through an optical glass element being the same as a color bin of the light emitted by an LED with a middle color bin in the first wavelength range after the light passes through the optical glass element, or being the same as a color bin of the light emitted by an LED with the middle color bin in the second wavelength range after the light passes through the optical glass element. The present invention can effectively increase a utilization rates of LEDs will and the cost will decrease effectively.

### BACKGROUND OF THE INVENTION

1. Field of the Invention

The present invention relates to a lightbar module and a backlight device, and more particularly, to a lightbar module and a backlight device capable of enhancing utilization rates of light-emitting diodes (LEDs).

2. Description of Prior Art

A liquid crystal display (LCD) comprises a backlight device and a liquid crystal (LC) module. The backlight device comprises a backlight light source, a housing, a diffuser plate, and other elements. The LC module is made of an LC panel and assembled frames. LEDs have been developed rapidly to replace conventional cold cathode fluorescent lamps (CCFLs) that serve as backlight light sources in LCDs because LEDs feature low power consumption and contain no mercury.

Nowadays, LEDs are disposed on a printed circuit board (PCB) or a flexible printed circuit board (FPC) to form a lightbar module in a display where LEDs serve as light sources. With regards to LEDs of the lightbar module, LED finished products are sifted according to a predetermined specification to classify LEDs in mass production. In general, to classify LEDs relies on several performance indexes, including: brightness, chromaticity, wavelength, or forward voltage of LEDs. LEDs are classified according to these performance indexes. LEDs with a certain primary color bin are usually selected by panel manufacturers. Conventionally, LEDs complying with a preferred chromaticity specification can only be used in light sources. In other words, LEDs with other color bins are not used by panel manufacturers. In this way, the quantity of the selected LEDs accounts for a small proportion of total LED production.

Refer to FIG. 1, which is a conventional LCD color binning chart. A3 is a color bin for the required white light. A1 and A2 are color bins for bluer light compared with the required white light. A4 and A5 are color bins for yellower light compared with the required white light. In order to enhance utilization rates of LEDs, LEDs with complementary chromaticities in color bins are usually selected. The LEDs are mixed and arranged on a lightbar module to produce an expected total illuminating chromaticity. For example, in order to use manufactured LEDs 32 in batches effectively, LEDs with the color bin A1 are selected to be adjacent to LEDs with the color bin A5. Or, LEDs with the color bin A2 and with the color bin A4 are selected to be adjacent. The color bin of the mix light emitted by the combination of adjacent LEDs is A3. However, the color bins of every batch of manufactured LEDs are not symmetrical; that is, the quantity of LEDs with the color bin A1 is not equal to that of LEDs with the color bin A5, and the quantity of LEDs with the color bin A2 is not equal to that of LEDs with the color bin A4. So it is not possible to fully utilize every batch of manufactured LEDs each time.

Therefore, it is required to provide a lightbar module and backlight device thereof to solve problems occurring in the prior art.

### SUMMARY OF THE INVENTION

One object of the present invention is to provide a lightbar module which is arranged according to LED color bins. According to the present invention, a lightbar module comprises a plurality of light source units. The light source unit comprises at least one first light-emitting diode (LED) with a first color bin in a first wavelength range and at least one second LED with a second color bin in a second wavelength range. A color bin created by the mixed light of the light emitted by the first LED and the light emitted by the second LED after the mixed light passes through an optical glass element is the same as a color bin of the light emitted by an LED with a middle color bin in the first wavelength range after the light passes through the optical glass element, or is the same as a color bin of the light emitted by an LED with the middle color bin in the second wavelength range after the light passes through the optical glass element.

Another object of the present invention is to provide a lightbar module which is strip-shaped and comprises a plurality of light source units. The light source unit comprises at least one first light-emitting diode (LED) with a first color bin in a first wavelength range and at least one second LED with a second color bin in a second wavelength range. A color bin created by the mixed light of the light emitted by the first LED and the light emitted by the second LED after the mixed light passes through an optical glass element is the same as a color bin of the light emitted by an LED with a middle color bin in the first wavelength range after the light passes through the optical glass element, or is the same as a color bin of the light emitted by an LED with the middle color bin in the second wavelength range after the light passes through the optical glass element.

Still another object of the present invention is to provide a backlight device having a lightbar module which comprises a plurality of light source units. The light source unit comprises at least one first light-emitting diode (LED) with a first color bin in a first wavelength range and at least one second LED with a second color bin in a second wavelength range. A color bin created by the mixed light of the light emitted by the first LED and the light emitted by the second LED after the mixed light passes through an optical glass element is the same as a color bin of the light emitted by an LED with a middle color bin in the first wavelength range after the light passes through the optical glass element, or is the same as a color bin of the light emitted by an LED with the middle color bin in the second wavelength range after the light passes through the optical glass element.

According to the lightbar module and the backlight device provided by the present invention, utilization rates of LEDs used in backlight devices increase compared with the prior art. Besides, the lightbar module and the backlight device of the present invention are no longer restricted to the conventional technology where only a set of LEDs with the same bin can be chosen. So, when backlight devices and lightbar modules are manufactured, utilization rates of LEDs will increase effectively and the cost will decrease effectively.

### BRIEF DESCRIPTION OF THE DRAWINGS

FIG. 1 shows a conventional LCD color binning chart.

FIG. 2 shows a representative LCD color binning chart according to the present invention.

FIG. 3 is a schematic diagram illustrating a lightbar module according to a first embodiment of the present invention.

FIG. 4 is a schematic diagram illustrating a lightbar module according to a second embodiment of the present invention.

FIG. 5 is a schematic diagram illustrating a lightbar module according to a third embodiment of the present invention.

FIG. 6 is a schematic diagram illustrating a lightbar module according to a fourth embodiment of the present invention.

FIG. 7 is a schematic diagram illustrating a lightbar module according to a fifth embodiment of the present invention.

FIG. 8 is a schematic diagram illustrating a lightbar module according to a sixth embodiment of the present invention.

FIG. 9 is a schematic diagram illustrating an edge-lighting-type backlight device according to a second embodiment of the present invention.

FIG. 10 is a schematic diagram illustrating a bottom-lighting-type backlight device according to a second embodiment of the present invention.

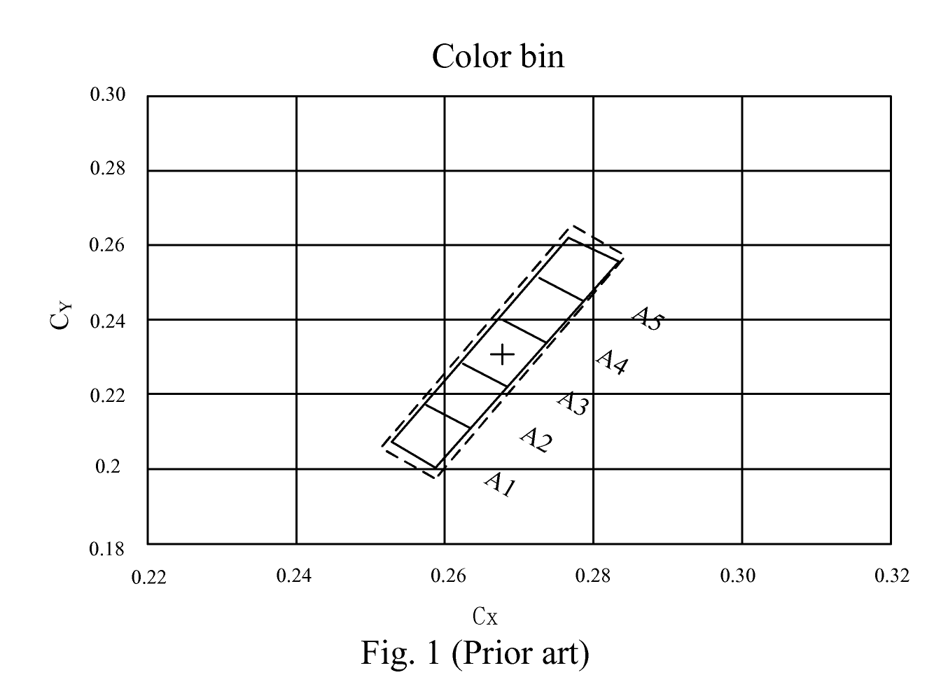

### DETAILED DESCRIPTION OF THE PREFERRED EMBODIMENTS

These and other features, aspects and advantages of the present disclosure will become understood with reference to the following description, appended claims and accompanying figures.

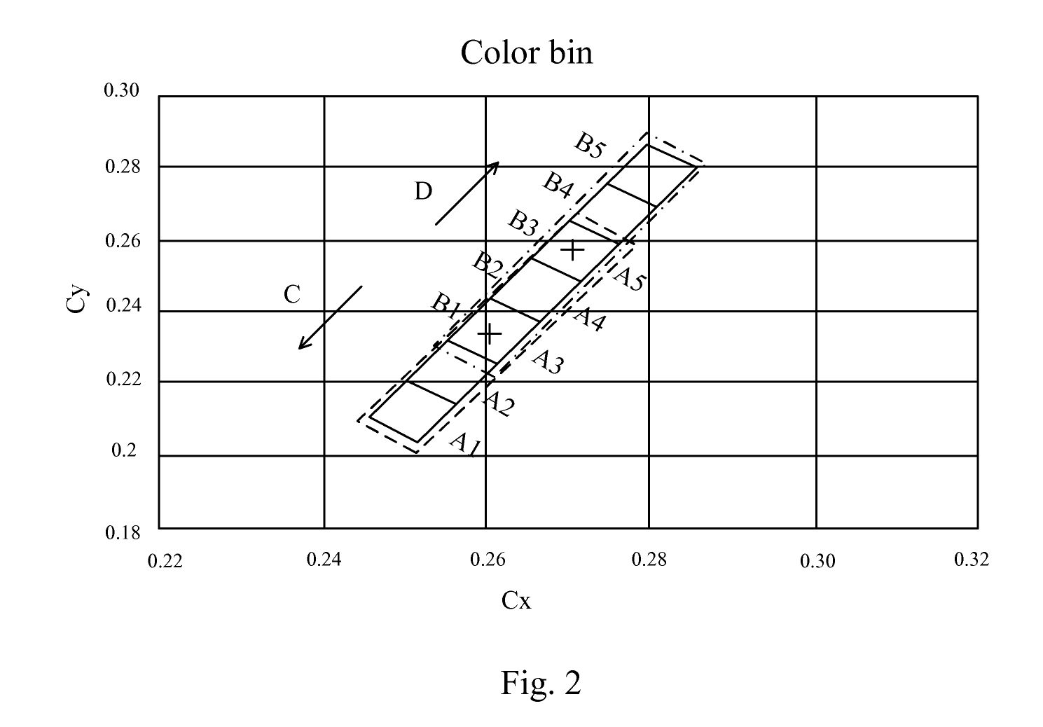

Please refer to FIG. 2, which shows a representative LCD color binning chart according to the present invention. LEDs are manufactured in mass production. The batches of LEDs are sifted according to a chromaticity value specification and are classified into diverse color bins. For instance, a first wavelength range Wp1 corresponding to a first group of LEDs is approximately 440-445 nm. A second wavelength range Wp2 corresponding to a second group of LEDs is approximately 445-451 nm. A1 to A5 are the distribution of color bins in the first wavelength range Wp1. B1 to B5 are the distribution of color bins in the second wavelength range Wp2. Because of the phenomenon of showing the same chromaticity with different spectra, wavelengths of the light beam emitted by LEDs still have slight differences even in the same chromaticity. For instance, in order to make LCDs have the same chromaticity eventually, the required white point chromaticity for LEDs is A3 in the first wavelength range Wp1 and B3 in the second wavelength range Wp2. Generally speaking, color bins (e.g., A3 and B3) in the middle position of each range of wavelengths Wp1 and Wp2 are middle chromaticities. Practically, the illuminating chromaticity displayed by the middle chromaticities is white light. On the basis of A3 or B3, the chromaticity moves toward the blue color range of the visible light spectrum (cool colors) in a direction C and toward the pink color range of the visible light spectrum (warm colors) in a direction D.

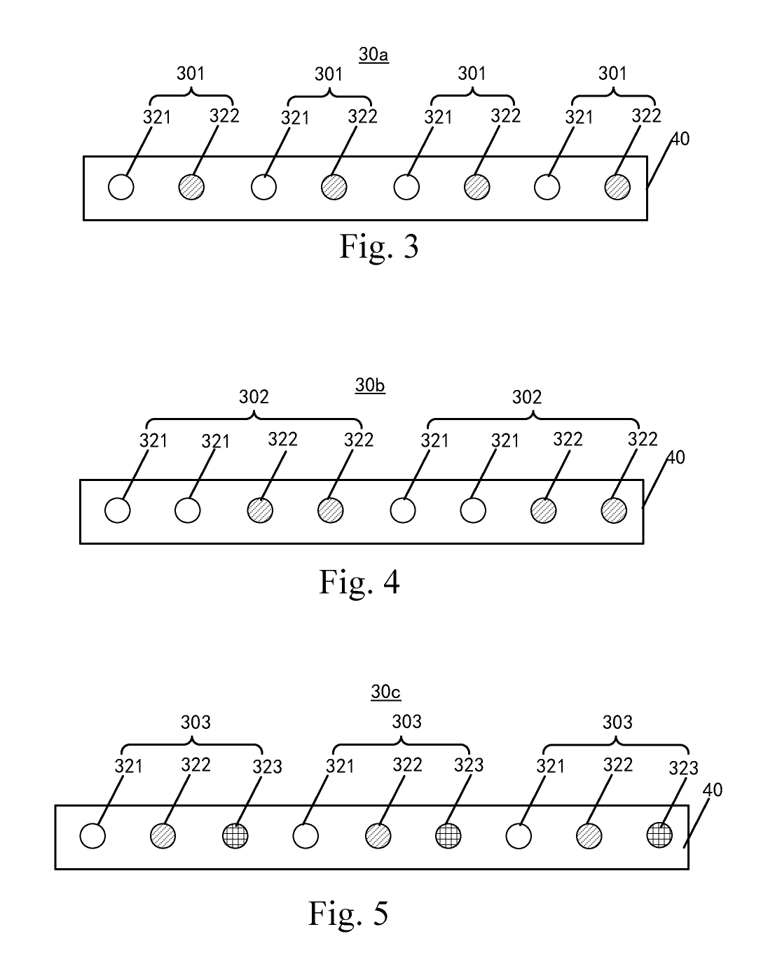

Refer to FIG. 2 and FIG. 3. FIG. 3 is a schematic diagram illustrating a lightbar module 30a according to a first embodiment of the present invention. The lightbar module 30a comprises a plurality of light source units 301. The plurality of light source units 301 are arranged on a circuit board substrate 40. In order to use each batch of manufactured LEDs more effectively, each batch of LEDs is classified into a first group of LEDs and a second group of LEDs. The first group of LEDs belongs to the first wavelength range Wp1 (e.g., 440-445 nm) and has a distribution of the color bins A1-A5 in the first wavelength range Wp1. The second group of LEDs belongs to the second wavelength range Wp2 (e.g., 445-451 nm) and has a distribution of the color bins B1-B5 in the second wavelength range Wp2. Each of the light source units 301 comprises an LED 321 and an LED 322. The LEDs 321 and 322 are alternatively arranged in a one-to-one correspondence. LEDs with the color bin A1 in the first group of LEDs (the first wavelength range Wp1) and LEDs with the color bin B5 in the second group of LEDs (the second wavelength range Wp2) are selected as the LED 321 and the LED 322, respectively. Or, LEDs with the color bin A2 in the first group of LEDs (the first wavelength range Wp1) and LEDs with the color bin B4 in the second group of LEDs (the second wavelength range Wp2) are selected as the LED 321 and the LED 322, respectively. Or, LEDs with the color bin A4 in the first group of LEDs (the first wavelength range Wp1) and LEDs with the color bin B2 in the second group of LEDs (the second wavelength range Wp2) are selected as the LED 321 and the LED 322, respectively. Or, LEDs with the color bin A5 in the first group of LEDs (the first wavelength range Wp1) and LEDs with the color bin B1 in the second group of LEDs (the second wavelength range Wp2) are selected as the LED 321 and the LED 322, respectively. The light emitted by the LED 321 is mixed with the light emitted by the LED 322. The mixed light from the LED 321 and 322 passes through an optical glass element to show a complementary color bin. The complementary color bin matches a color bin of the light emitted by an LED with a middle color bin A3 in the first wavelength range Wp1 after the light passes through the optical glass element, or a color bin of the light emitted by an LED with the middle color bin B3 in the second wavelength range Wp2 after the light passes through the optical glass element. In other words, a color bin created by the mixed light of each light source unit 301 after the mixed light passes through an optical glass element is the same as a color bin of the light emitted by an LED with the middle color bin A3 in the first wavelength range Wp1 after the light passes through the optical glass element, or is the same as a color bin of the light emitted by an LED with the middle color bin B3 in the second wavelength range Wp2 after the light passes through the optical glass element.

Refer to FIG. 2 and FIG. 4. FIG. 4 is a schematic diagram illustrating a lightbar module 30b according to a second embodiment of the present invention. Differing from the first embodiment, the lightbar module 30b comprises a plurality of light source units 302. The plurality of light source units 302 are arranged on a circuit board substrate 40. Each of the light source units 302 comprises two LEDs 321 and two LEDs 322. The LEDs 321 and the LEDs 322 are alternatively arranged in a two-to-two correspondence. LEDs with the color bin A1 in the first group of LEDs (the first wavelength range Wp1) and LEDs with the color bin B5 in the second group of LEDs (the second wavelength range Wp2) are selected as the LEDs 321 and the LEDs 322, respectively. Or, LEDs with the color bin A2 in the first group of LEDs (the first wavelength range Wp1) and LEDs with the color bin B4 in the second group of LEDs (the second wavelength range Wp2) are selected as the LED 321 and the LED 322, respectively. Or, LEDs with the color bin A4 in the first group of LEDs (the first wavelength range Wp1) and LEDs with the color bin B2 in the second group of LEDs (the second wavelength range Wp2) are selected as the LED 321 and the LED 322, respectively. Or, LEDs with the color bin A5 in the first group of LEDs (the first wavelength range Wp1) and LEDs with the color bin B1 in the second group of LEDs (the second wavelength range Wp2) are selected as the LED 321 and the LED 322, respectively. The light emitted by the LEDs 321 is mixed with the light emitted by the LEDs 322. The light emitted by the LED 321 is mixed with the light emitted by the LED 322. The mixed light from the LED 321 and 322 passes through an optical glass element to show a complementary color bin. The complementary color bin matches a color bin of the light emitted by an LED with a middle color bin A3 in the first wavelength range Wp1 after the light passes through the optical glass element, or a color bin of the light emitted by an LED with the middle color bin B3 in the second wavelength range Wp2 after the light passes through the optical glass element. In other words, a color bin created by the mixed light of each light source unit 302 after the mixed light passes through an optical glass element is the same as a color bin of the light emitted by an LED with the middle color bin A3 in the first wavelength range Wp1 after the light passes through the optical glass element, or is the same as a color bin of the light emitted by an LED with the middle color bin B3 in the second wavelength range Wp2 after the light passes through the optical glass element.

Refer to FIG. 2 and FIG. 5. FIG. 5 is a schematic diagram illustrating a lightbar module 30c according to a third embodiment of the present invention. The lightbar module 30c comprises a plurality of light source units 303. The plurality of light source units 303 are arranged on a circuit board substrate 40. Each of the light source units 303 comprises a first LED 321, a second LED 322, and a third LED 323. A selection method for choosing the LEDs 321 and 322 is the same as that in the previous embodiments. There is no need for further details. As for the third LED 323, the LED with the color bin A3 in the first group of LEDs (the first wavelength range Wp1) or the LED with the color bin B3 in the second group of LEDs (the second wavelength range Wp2) is selected. In this way, the light emitted by the LED 321, by the LED 322, and by the LED 323 is mixed. The mixed light from the LEDs 321, 322, and 323 passes through an optical glass element to show a complementary color bin. The complementary color bin matches a color bin of the light emitted by an LED with a middle color bin A3 in the first wavelength range Wp1 after the light passes through the optical glass element, or a color bin of the light emitted by an LED with the middle color bin B3 in the second wavelength range Wp2 after the light passes through the optical glass element. In other words, a color bin created by the mixed light of each light source unit 303 after the mixed light passes through an optical glass element is the same as a color bin of the light emitted by an LED with the middle color bin A3 in the first wavelength range Wp1 after the light passes through the optical glass element, or is the same as a color bin of the light emitted by an LED with the middle color bin B3 in the second wavelength range Wp2 after the light passes through the optical glass element. The arrangement order of the LEDs 321, 322, and 323 is not restricted to the order shown in FIG. 5. For example, the LED 323 can be placed between the LED 321 and the LED 322.

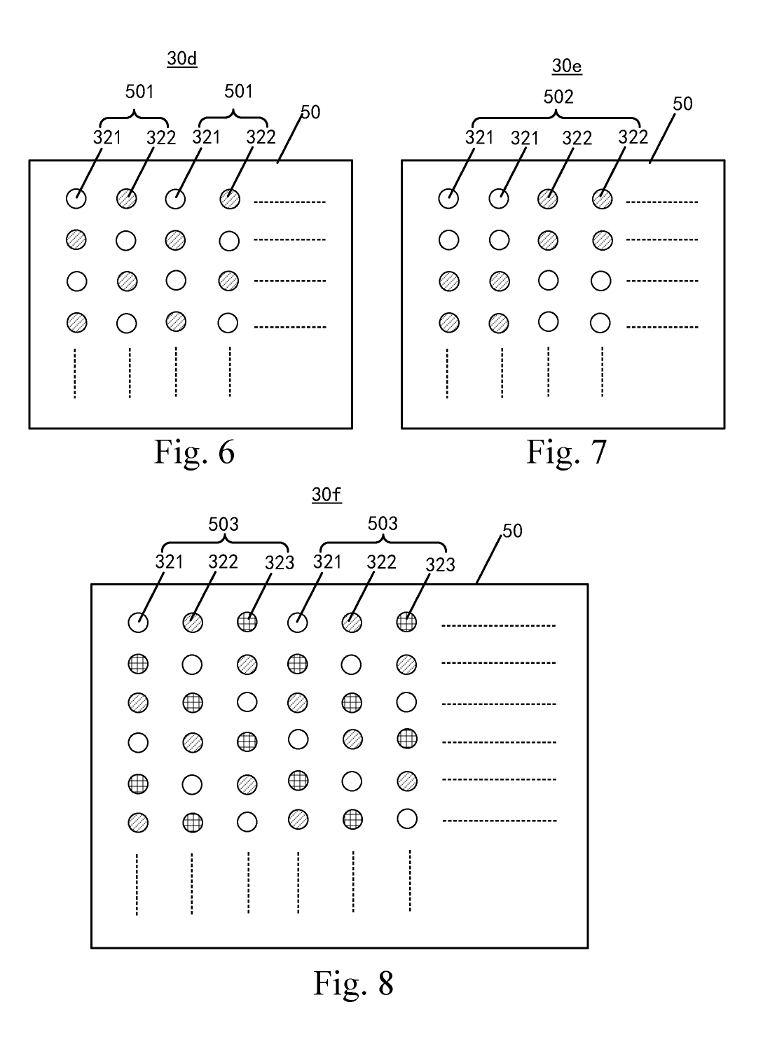

Refer to FIG. 6 showing a schematic diagram illustrating a lightbar module 30d according to a fourth embodiment of the present invention. The lightbar module 30d comprises a plurality of light source unit 501 disposed on the circuit board substrate 50. The light source unit 501 comprises a first LED 321 and a second LED 322. Because the first LED 321 and the second LED 322 are selected and arranged by the same rules as the first embodiment illustrated in FIG. 3, and thus further description is omitted.

Refer to FIG. 7 showing a schematic diagram illustrating a lightbar module 30e according to a fifth embodiment of the present invention. The lightbar module 30e comprises a plurality of light source unit 502 disposed on the circuit board substrate 50. The light source unit 502 comprises two first LEDs 321 and two second LEDs 322. Because the two first LEDs 321 and the two second LEDs 322 are selected and arranged by the same rules as the second embodiment illustrated in FIG. 4, and thus further description is omitted.

Refer to FIG. 8 showing a schematic diagram illustrating a lightbar module 30f according to a sixth embodiment of the present invention. The lightbar module 30f comprises a plurality of light source unit 503 disposed on the circuit board substrate 50. The light source unit 503 comprises a first LED 321, a second LED 322, and a third LED 323. Because the first LED 321, the second LED 322, and the third LED 323 are selected and arranged by the same rules as the third embodiment illustrated in FIG. 5, and thus further description is omitted.

The lightbar modules 30d, 30b, 30f in FIGS. 6-8 may be a combination of lightbar modules 30a, 30b, 30c in FIGS. 3-5, respectively. In addition, the LEDs 321, 322, 323 are disposed on a circuit board substrate 40, 50 such as a flexible printed circuit board (FPC) or a printed circuit board (PCB), or a metallic substrate.

It is notified that, the description of the above-mentioned embodiments is based on the color bin of white light as the targeted light. In other embodiments, blue light, red light, green light, or other wavelengths of light can also be targeted light depending on actual demands. And then, the manufactured LEDs are categorized into at least two sets of LEDs with different ranges of wavelengths according to their individual corresponding ranges of wavelengths. Finally, one LED is selected from each set of LEDs. The selected LEDs are mixed to form a light source unit. The light emitted by the light source unit matches the target color.

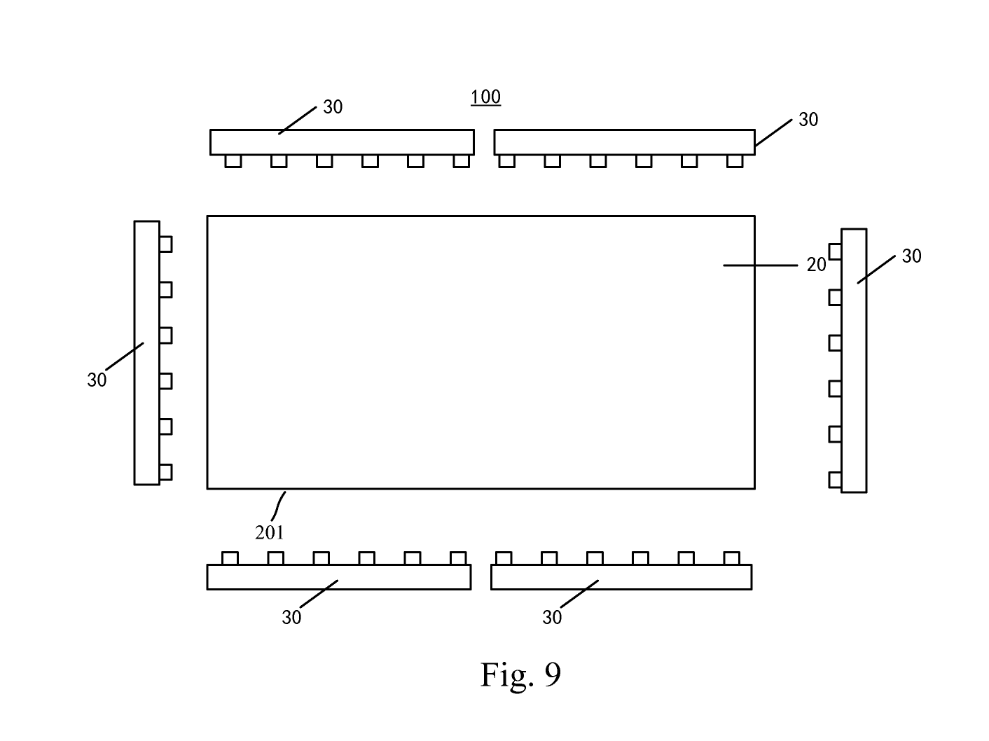

Refer to FIG. 9, which is a schematic diagram illustrating a lightbar module 30 used in an edge-lighting-type LCD backlight device 100. The lightbar module 30 is selected from a group consisting of the lightbar modules 30a-30f. The edge-lighting-type LCD backlight device 100 comprises a light guide plate (LGP) 20 and the lightbar module 30. The lightbar module 30 is installed at all four sides of the LGP 20 for emitting light with a specific color. Although the lightbar module 30 is installed at all four sides of the LGP 20 according to this embodiment, the lightbar module 30 can also be installed at any one side, any two sides, or any three sides of the LGP 20 according other embodiments. The incidence surface of the LGP 20 facing the lightbar module 30 can be flat or zigzag-shaped, or can have a plurality of concaves or a plurality of convexes.

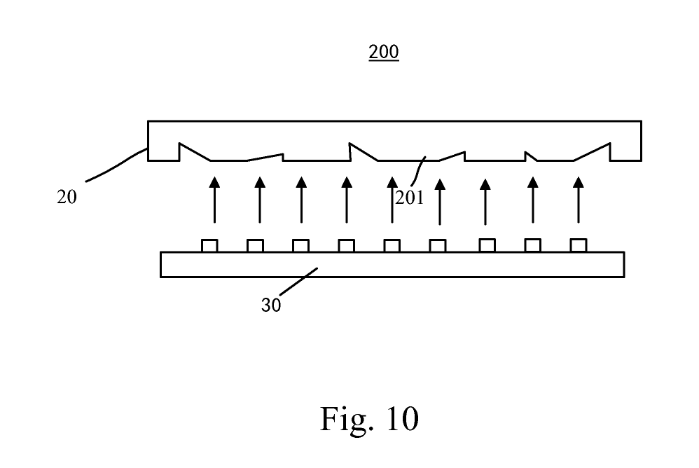

Refer to FIG. 10, which is a schematic diagram illustrating the lightbar module 30 used in a bottom-lighting-type LCD backlight device 200. The bottom-lighting-type LCD backlight device 200 comprises the LGP 20 and the lightbar module 30. The lightbar module 30 is selected from the lightbar modules 30a-30f. The lightbar module 30 is installed at the bottom of the bottom-lighting-type LED backlight device 200. The LGP 20 is mounted on the lightbar module 30. The incidence surface of the LGP 20 facing the lightbar module 30 can be flat or zigzag-shaped, or can have a plurality of concaves or a plurality of convexes.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A lightbar module, characterized in that, the lightbar module is strip-shaped and comprises a plurality of light source units, the light source unit comprising at least one first light-emitting diode (LED) with a first color bin in a first wavelength range and at least one second LED with a second color bin in a second wavelength range, a color bin created by the mixed light of the light emitted by the first LED and the light emitted by the second LED after the mixed light passes through an optical glass element being the same as a color bin of the light emitted by an LED with a middle color bin in the first wavelength range after the light passes through the optical glass element, or being the same as a color bin of the light emitted by an LED with the middle color bin in the second wavelength range after the light passes through the optical glass element.

2. The lightbar module of claim 1, characterized in that the first LED and the second LED of each of the light source units are alternatively arranged in a one-to-one correspondence.

3. The lightbar module of claim 1, characterized in that each of the light source units comprises two first LEDs and two second LEDs, and the two first LEDs and the two second LEDs are alternatively arranged in a two-to-two correspondence.

4. The lightbar module of claim 1, characterized in that each of the light source units further comprises a third LED selected from LEDs with the middle color bin in the first wavelength range or from LEDs with the middle color bin in the second wavelength range.

5. A lightbar module, characterized in that, the lightbar module comprises a plurality of light source units, the light source unit comprising at least one first light-emitting diode (LED) with a first color bin in a first wavelength range and at least one second LED with a second color bin in a second wavelength range, a color bin created by the mixed light of the light emitted by the first LED and the light emitted by the second LED after the mixed light passes through an optical glass element being the same as a color bin of the light emitted by an LED with a middle color bin in the first wavelength range after the light passes through the optical glass element, or being the same as a color bin of the light emitted by an LED with the middle color bin in the second wavelength range after the light passes through the optical glass element.

6. The lightbar module of claim 5, characterized in that the first LED and the second LED of each of the light source units are alternatively arranged in a one-to-one correspondence.

7. The lightbar module of claim 5, characterized in that each of the light source units comprises two first LEDs and two second LEDs, and the two first LEDs and the two second LEDs are alternatively arranged in a two-to-two correspondence.

8. The lightbar module of claim 5, characterized in that each of the light source units further comprises a third LED selected from LEDs with the middle color bin in the first wavelength range or from LEDs with the middle color bin in the second wavelength range.

9. The lightbar module of claim 5, characterized in that the lightbar module is strip-shaped.

10. The lightbar module of claim 5, characterized in that the lightbar module is block-shaped.

11. The lightbar module of claim 5, characterized in that the light with the middle color bin is white light.

12. A backlight device characterized in that, the backlight device comprises the lightbar module of claim 5.

13. The backlight device of claim 12, characterized in that the first LED and the second LED of each of the light source units are alternatively arranged in a one-to-one correspondence.

14. The backlight device of claim 12, characterized in that each of the light source units comprises two first LEDs and two second LEDs, and the two first LEDs and the two second LEDs are alternatively arranged in a two-to-two correspondence.

15. The backlight device of claim 12, characterized in that each of the light source units further comprises a third LED selected from LEDs with the middle color bin in the first wavelength range or from LEDs with the middle color bin in the second wavelength range.

16. The backlight device of claim 12, characterized in that the lightbar module is strip-shaped.

17. The backlight device of claim 12, characterized in that the lightbar module is block-shaped.

18. The backlight device of claim 12, characterized in that a color bin created by the mixed light of the light emitted by the LEDs after the mixed light passes through an optical glass element is the same as the color bin of the light emitted by an LED with the middle color bin after the light passes through the optical glass element.

19. The backlight device of claim 12, characterized in that the backlight device is a bottom-lighting-type backlight device.

20. The backlight device of claim 12, characterized in that the backlight device is an edge-lighting-type backlight device.
